(19) United States
(12) Patent Application Publication
(10) Pub. No.: US 2024/0178411 A1
(43) Pub. Date: May 30, 2024

(54) SEPARATOR PLATE

(71) Applicant: SGL CARBON SE, Wiesbaden (DE)

(72) Inventors: Oswin OETTINGER, Meitingen (DE); Jonas SCHMITZ, Meitingen (DE); Fabian SCHUBERT, Meitingen (DE); Jennifer KAMMERMEIER, Meitingen (DE); Norma Karla MINAR, Meitingen (DE)

(73) Assignee: SGL CARBON SE, Wiesbaden (DE)

(21) Appl. No.: 18/553,375

(22) PCT Filed: Mar. 22, 2022
(86) PCT No.: PCT/EP2022/057454

§ 371 Date: Sep. 29, 2023

(30) Foreign Application Priority Data
Mar. 31, 2021 (DE) 10 2021 203 265.6

(51) Int. Cl. H01M 8/0245; H01M 8/0234; H01M 8/0239

(52) U.S. Cl. CPC H01M 8/0245; H01M 8/0234; H01M 8/0239

(57) ABSTRACT

A separator plate, a method for producing the separator plate and its use.

The present invention relates to a separator plate, a method for producing the separator plate and its use.

Separator plates or bipolar plates in proton exchange membrane (PEM) fuel cells, phosphoric acid fuel cells or redox flow batteries are either metal-based or carbon-based. Although metal plates are very stable and can be very thin (<0.2 mm), it is necessary to protect the metal from corrosion and to thus increase the service life of the overall system. Metal plates are often coated with precious metals or carbon/graphite to protect them against corrosion. This approach has the disadvantage that it is very expensive. Carbon-based plates do not have any corrosion problems but are mechanically less stable and therefore have high wall thicknesses, typically of greater than 0.6 mm. The high wall thicknesses have a negative effect both on the construction volume and the weight of the overall system and result in higher costs due to the higher production cost and use of materials. In addition, it is advantageous if the separator plate can be produced as endless material since the end product is installed in large numbers and this reduces production costs.

Carbon fibre papers are known as primary products for gas diffusion layers in fuel cells or redox flow batteries, as described for example in EP1369528B1. The method described there can be carried out in a continuous process. The carbon fibre paper is impregnated with a phenolic resin slurry and then carbonised or graphitised (see embodiment 1 of EP1369528B1). The carbon fibre paper and also the first intermediate product after the slurry impregnation and carbonisation/graphitisation have a very high porosity, which means that they have a very high permeability and a low mechanical stability.

The object of the present invention is therefore to provide a separator plate, as well as its production and use, which overcomes the disadvantages of the prior art described above.

The object is achieved by providing a separator plate comprising a monolayer of carbon fibre-reinforced carbon impregnated with a duromer resin, the separator plate having a continuous electrically conductive carbon network and a thickness of less than 0.5 mm, preferably 0.1 to 0.3 mm, as well as a tensile strength greater than 30 MPa, preferably greater than 35 MPa, particularly preferably greater than 45 MPa.

In the context of the invention, a continuous electrically conductive network is understood to refer to a network that is not interrupted.

The thickness of the separator plate is understood to refer to the wall thickness, with a thickness of less than 0.5 mm having the advantage that it is mechanically stable enough and has less weight, and therefore requires less construction volume within the layer structure of the overall fuel cell. With a tensile strength of more than 30 MPa, the separator plate is sufficiently mechanically stable, which is why it can be produced and manipulated with a small thickness. At a thickness larger than 0.5 mm, the volume resistance increases so significantly that the overall fuel cell becomes inefficient.

According to the invention, the separator plate has a volume resistance of less than 8 mΩcm², preferably less than 5 mΩcm², particularly preferably less than 3 mΩcm². If the volume resistance is greater than 8 mΩcm², the ohmic losses become too high and the fuel cell loses efficiency, for example, and heats up too much. The measurement of volume resistance is described below.

The separator plate advantageously has a density of less than 1.7 g/cm³, preferably less than 1.4 g/cm³, particularly preferably less than 1.3 g/cm³. With a density of greater than 1.7 g/cm³, the disadvantages of the resulting higher weight of the separator plate have a negative effect.

According to the invention, carbon fibre-reinforced carbon comprises a monolayer of a carbon fibre textile with carbon binder bridges between the carbon fibres. This allows for a particularly thin and high-tensile separator plate due to the fibre reinforcement with a conductivity which is still good due to the carbon binder bridges between the carbon fibres, which creates a continuous electrical conductivity network.

Advantageously, the carbon fibre textile is from the group of carbon fibre paper, carbon fibre nonwoven fabric, carbon fibre fabric or staple fibre fabric.

In the production of carbon fibre paper, a slurry of an aqueous short carbon fibre binder mixture is deposited on a screen in the paper machine. After the drying step, the short cut fibres combine with each other and the carbon fibres are aligned in the plane of the paper in a planar orientation (two-dimensional structure). Carbon fibre nonwoven fabrics, on the other hand, are three-dimensional structures that are produced by a wet or dry laying of short fibres, with the three-dimensional structure being produced by a mechanical strengthening process that uses needles or water jets. Carbon fibre fabrics are textile fabrics that have at least two thread systems that do not extend parallel and thus intersect. Staple fibre fabrics are woven yarns made from stretch-broken and twisted filaments.

According to the invention, the duromer resin comprises resins from the group of epoxy resin, phenolic resin, furan resin or benzoxazine resin.

The duromer resin closes the pores of the carbon fibre textile while maintaining the conductivity based on the carbon network. Furthermore, this increases the density and mechanical strength.

Advantageously, the duromer resin comprises dispersed fillers.

The fillers are selected from the group of carbon black, expanded graphite, natural or synthetic graphite, ground carbon fibres or mixtures thereof. The fillers can further increase the conductivity since the continuous conductive carbon network is further expanded by the fillers. Depending on the morphology of the filler particles, they can also have positive effects on the density of the separator plate, for example by preventing the formation of pores due to a better wetting of the carbon network to be impregnated or by forming a toothed layer as a gas barrier in the case of a platelet-like anisotropic morphology.

According to the invention, the mass fraction of fillers is 0 wt. % to 40 wt. %, preferably 5 wt. % to 20 wt. %, particularly preferably 8 wt. % to 15 wt. %. Less than 5 wt. % does not lead to a sufficient increase in conductivity, and more than 40 wt. % leads to high viscosities which can result in problems with the complete impregnation.

Advantageously, the cross section of the separator plate has a concentration gradient of the fillers. This means that, depending on the size and morphology of the particles, the fillers can remain predominantly on the surface, causing a concentration gradient to form. This means that there is a higher concentration of fillers in the outer region of the separator plate and a lower concentration of fillers in the inner region of the separator plate. The concentration gradient depends on the type of filler and in particular the particle size. The fact that the fillers remain predominantly on the surface further increases the density of the separator plate, improves conductivity and reduces contact resistance.

The separator plate advantageously has a permeation coefficient of less than 5×10⁻⁵ cm²/s, preferably less than 1×10⁻⁵ cm²/s. With a permeation coefficient of less than 5×10⁻⁵ cm²/s, the separator plate is considered a technically dense separator plate; i.e., the technical density satisfies the requirements for use as a separator plate for different gas or liquid spaces.

According to the invention, the surface of the carbon fibre-reinforced carbon impregnated with the duromer resin has a structuring. The structuring allows for a targeted and controlled supply of gases/liquids and the removal of any reaction products that may arise. In addition, the structuring can be used for water cooling the stack structure.

Another subject matter of the invention is a method for producing the separator plate, comprising the following steps:
a) Provision of a carbon fibre textile
b) Impregnation of the carbon fibre textile with a carbon donor
c) High-temperature treatment of the impregnated carbon fibre textile in an inert gas atmosphere at temperatures greater than 1300° C., preferably greater than 1700° C., particularly preferably greater than 2000° C.
d) Provision of a duromer resin system
e) Impregnation of the carbon fibre-reinforced carbon obtained in step c) with the duromer resin system provided in step d)
f) Hardening and pressing of the resin-impregnated carbon fibre-reinforced carbon from step e) under a pressure of 1-50 bar

In the context of the invention, a carbon donor in step b) is understood to refer to a resin with a carbon yield of greater than 20 wt. %, which can additionally be filled with carbon, graphite or carbon black. An inert gas atmosphere is understood to refer to a nitrogen or argon atmosphere. The impregnation steps b) and e) can be carried out on one side or on both sides. The impregnation by means of the duromer resin system as well as the hardening and the pressing in steps e) and f) increase the density and the mechanical strength of the carbon fibre-reinforced carbon, which is why the separator plate can have a very thin design.

Following step f), the surface can advantageously be activated by a grinding, blasting, chemical treatment or plasma treatment on both sides. The activation can remove any electrically insulating layer (resin layer) that may be present on the separator plate.

Advantageously, 0 wt. % to 40 wt. %, preferably 5 wt. % to 20 wt. %, particularly preferably 8 wt. % to 15 wt. % fillers are dispersed in the duromer resin system. The fillers can furthermore increase or improve the conductivity and the density.

The pressing step is advantageously carried out with a structured tool. A tool is understood to refer to an embossing roller, forming roller or plate. A structured tool achieves a deformation in the pressing step. The pressing step allows the duromer resin system to penetrate further into the interior of the carbon fibre textile, it being possible for the fillers, depending on the size of the particles, to remain predominantly on the surface, causing a concentration gradient to form. This means that the separator plate has a concentration gradient in the cross section which decreases on both sides of the separator plate from the outside to the inside of the separator plate. The concentration gradient depends on the type of filler and in particular the particle size. Because the fillers remain predominantly on the surface, conductivity can be improved and the contact resistance reduced, making it possible to further increase the density of the separator plate.

According to the invention, the method can be carried out as a continuous or batch method. In particular the continuous method is advantageous.

Another subject matter is the use of the separator plate for redox flow batteries or fuel cells or as an electrode for electrostatic air-cleaning devices.

In the following, purely by way of example, the present invention is described by way of advantageous embodiments and with reference to the accompanying drawings.

FIG. 1: Separator plate (4) comprising a monolayer of carbon fibre-reinforced carbon (1) with a duromer resin (2)

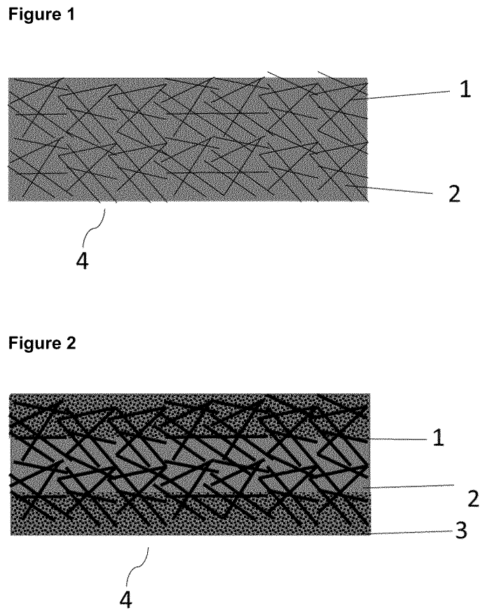

FIG. 2: Separator plate (4) comprising a monolayer of carbon fibre-reinforced carbon (1) with a duromer resin (2) and fillers (3)

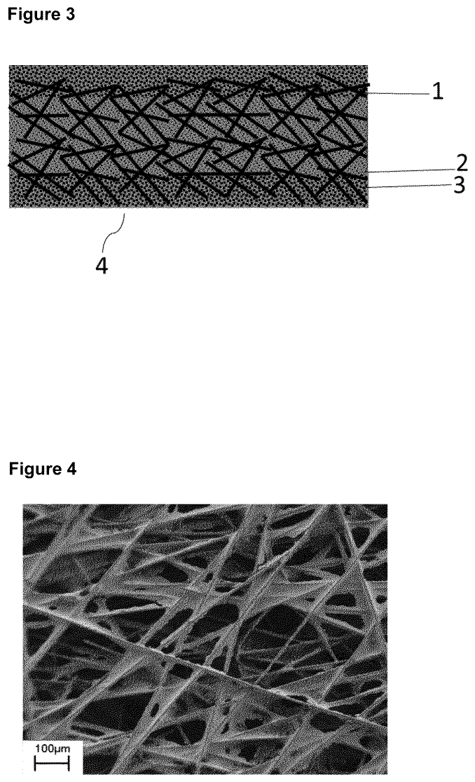

FIG. 3: Separator plate (4) comprising a monolayer of carbon fibre-reinforced carbon (1) with a duromer resin (2) and fillers (3)

FIG. 4: Scanning electron microscope (SEM) image of a monolayer of carbon fibre-reinforced carbon (1)

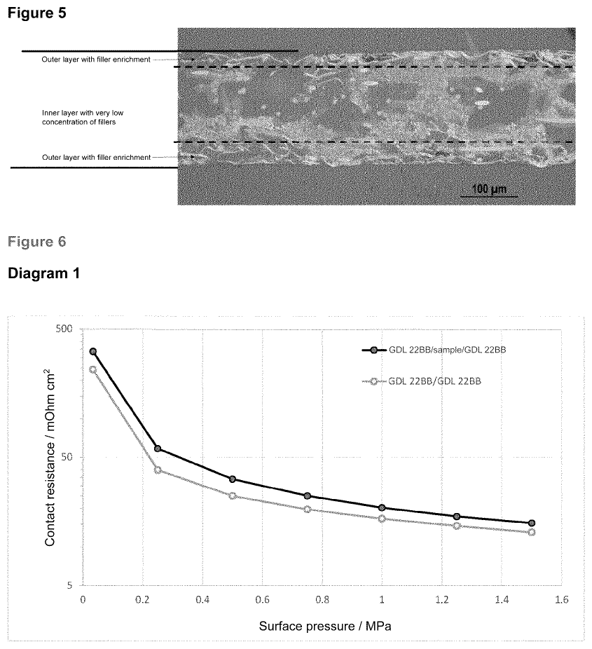

FIG. 5 shows a micrograph of a separator plate according to the invention Diagram 1: Volume resistance as a function of the surface pressure

FIG. 1 shows a separator plate (4) comprising a monolayer of carbon fibre-reinforced carbon (1) which is impregnated with a duromer resin (2).

FIG. 2 shows a separator plate (4) comprising a monolayer of carbon fibre-reinforced carbon (1) which is impregnated with a duromer resin (2) and has fillers (3). Due to the nature of the fillers, a concentration gradient occurs which ensures that the fillers only penetrate very little into the interior of the porous carbon fibre-reinforced carbon (1).

FIG. 3 shows a separator plate (4) comprising a monolayer of carbon fibre-reinforced carbon (1) which is impregnated with a duromer resin (2) and has fillers (3). Due to the different particle sizes of the filler, smaller particles penetrate further into the interior of the carbon fibre-reinforced carbon (1) than larger particles.

FIG. 4 shows an SEM image of a porous carbon fibre-reinforced carbon (1) before it is sealed with the duromer resin system. The carbon binder bridges between the carbon fibres are clearly visible. The combination of fibre and binder bridge creates the continuously conductive network.

FIG. 5 shows a micrograph of a separator plate according to the invention with the outer regions having an accumulation of filler and the filler concentration being lower on the inside.

Diagram 1 shows the volume resistance on the basis of the surface pressure. It becomes clear that the initially high volume resistance (at the low surface pressure) does not only represent the pure material resistance but also reflects a considerable proportion of the contact resistance. As the surface pressure increases, the contact resistance decreases and the measured volume resistance is dominated by contribution of the material resistance. With surface pressures in the range of 1-1.5 MPa, a stationary volume resistance level is almost reached. A surface pressure level of 1 MPa roughly corresponds to the real application conditions in a fuel cell stack. Diagram 1 shows embodiment 1 together with a reference measurement of the external GDL (gas diffusion layers). It can be seen that the additional material layer of the separator plate only contributes a small part to the overall resistance of the sandwich layer structure with 2 GDL layers.

The present invention is explained below using embodiments which, however, do not represent any limitation of the invention.

A separator plate can be produced as described below.

### MEASUREMENT METHODS

### Volume Resistance

In order to obtain an application-oriented measurement value for the volume resistance, the resulting hardened separator plate is measured in a layer sandwich analogous to the arrangement in a fuel cell between two gas diffusion layers (GDL 22BB; SIGRACET®). The volume resistance Rz is calculated using the following formula:

$${R}_{z} = \frac{Δ U \cdot A}{Δ I}$$

ΔU is the voltage between the electrodes, A is the surface area of the sample and ΔI is the current.

The electrodes are coated with gold to avoid any possible transition resistance caused by oxidized surfaces. During the measurement, different contact pressures from 5 psi (U.S. unit) to 1.5 MPa are applied and the layer thickness is determined simultaneously. In order to determine the influence of the additional material layers made of GDL 22BB, a reference measurement was carried out with only 2 GDL 22BB layers. Since the material resistances add up in this series connection, the material resistance of the sample can be determined as the difference between the resistance of the GDL 22BB/sample/GDL 22BB layer structure and the reference measurement of two GDL 22BB layers.

### Permeation Coefficient

The permeation coefficient is measured according to DIN 51935:2019-06.

### Strength

The strength was determined by means of tensile strength tests based on DIN EN ISO 13934-1:2013-08. While in the standard-compliant test, beams with a length of 160 mm and a consistently constant width of 50 mm are used as the test specimen geometry, a tapered specimen geometry was used in deviation from this which also has a width of 50 mm with the same length in the free crack length but has a width of 80 mm in the clamping region in order to avoid failure within the clamping region.

### Density

The geometric density was determined by weighing a circular sample with a diameter of 50 mm.

The monolayer of carbon fibre-reinforced carbon can be produced, for example, as described in EP1369528B1.

### Embodiment 1

A monolayer of carbon fibre-reinforced carbon (1) with a thickness of 225 μm (measured at a load of 5 psi) (commercially available from SGL Carbon GmbH with the designation GDL 36 AA; SIGRACET®) is coated on one side with a 180 μm thick epoxy resin film (2) using a film applicator, with 7 wt. % of conductive carbon black (Super P from Imerys Graphite & Carbon) being dispersed in the epoxy resin. The coated monolayer is then hardened in a hot press for 60 minutes at a pressure of 32.5 bar and 130° C.

The volume resistance at a 1 MPa pressure is 7.8 mOhm cm². The permeation coefficient is 2.2*10⁻⁶ cm²/s. The thickness of the separator plate obtained in this manner is 210 μm (measured at a load of 5 psi). The geometric density is 1.14 g/cm. The tensile strength is 47 MPa.

### Embodiment 2

A monolayer of carbon fibre-reinforced carbon (1) with a thickness of 225 μm (measured at a load of 5 psi) (commercially available from SGL Carbon GmbH with the designation GDL 36 AA; SIGRACET®) is coated on both sides with a 130 um thick epoxy resin film (2), with 9 wt. % of expanded graphite (Sigratherm® GFG5 from SGL Carbon) being dispersed in the epoxy resin. The coated monolayer is then hardened in a hot press for 60 minutes at a pressure of 32.5 bar and 130° C.

The volume resistance at a 1 MPa surface pressure is 7.7 mOhm cm². The permeation coefficient is 1.4*10⁻⁵ cm²/s. The thickness of the separator plate obtained in this manner is 200 μm (measured at a load of 5 psi). The geometric density is 1.18 g/cm³. The tensile strength is 39 MPa.

### Embodiment 3

A monolayer of carbon fibre-reinforced carbon (1) with a thickness of 225 μm (measured at a load of 5 psi) (commercially available from SGL Carbon GmbH with the designation GDL 36 AA; SIGRACET®) is coated on one side with a 180 μm thick epoxy resin film (2) using a film applicator, with 9 wt. % of conductive carbon black (Super P from Imerys Graphite & Carbon) being dispersed in the epoxy resin. The coated monolayer is then hardened in a hot press for 60 minutes at a pressure of 32.5 bar and 130° C.

The volume resistance at 1 MPa pressure is 3.8 mOhm cm². The permeation coefficient is 5.5*10⁻⁶ cm²/s. The thickness of the separator plate obtained in this manner is 202 μm (measured at a load of 5 psi), and the geometric density is 1.04 g/cm³

### Embodiment 4

A monolayer of carbon fibre-reinforced carbon (1) with a thickness of 225 μm (measured at a load of 5 psi) (commercially available from SGL Carbon GmbH with the designation GDL 36 AA; SIGRACET®) is coated on one side with a 180 μm thick epoxy resin film (2), with 10 wt. % of fillers being dispersed in the epoxy resin. The 10 wt. % is made up of conductive carbon black (Super P from Imerys) and expanded graphite (Sigratherm® GFG5 from SGL Carbon) in a ratio of 70 to 30. The coated monolayer is then hardened in a hot press for 60 minutes at a pressure of 32.5 bar and 130° C.

The volume resistance at a 1 MPa surface pressure is 6.2 mOhm cm². The permeation coefficient is 2.2*10⁻⁶ cm²/s. The thickness of the separator plate obtained in this manner is 220 μm (measured at a load of 5 psi), and the geometric density is 1.18 g/cm³.

### Embodiment 5

A monolayer of carbon fibre-reinforced carbon (1) with a thickness of 225 μm (measured at a load of 5 psi) (commercially available from SGL Carbon GmbH with the designation GDL 36 AA; SIGRACET®) is coated on one side with a 180 μm thick epoxy resin film (2), with 10 wt. % of fillers being dispersed in the epoxy resin. The 10 wt. % is made up of conductive carbon black (Super P from the company Imerys Graphite & Carbon) and expanded graphite (Sigratherm® GFG5 from SGL Carbon) in a ratio of 30 to 70. The coated monolayer is then hardened in a hot press for 60 minutes at a pressure of 32.5 bar and 130° C.

The volume resistance at a 1 MPa surface pressure is 8 mOhm cm². The permeation coefficient is 3.7*10⁻⁶ cm²/s. The thickness of the separator plate obtained in this manner is 208 μm (measured at a load of 5 psi), and the geometric density is 1.04 g/cm³.

### Embodiment 6

A monolayer of carbon fibre-reinforced carbon (1) with a thickness of 225 μm (measured at a load of 5 psi) (commercially available from SGL Carbon GmbH with the designation GDL 36 AA; SIGRACET®) is coated on one side with a 180 μm thick epoxy resin film (2) using a film applicator, with 7 wt. % of conductive carbon black (Super P from the company Imerys Graphite & Carbon) being dispersed in the epoxy resin. The coated monolayer is then hardened in a hot press for 60 minutes at a pressure of 10 bar and 130° C.

The volume resistance at a 1 MPa pressure is 5.4 mOhm cm². The permeation coefficient is 3.9*10⁻⁶ cm²/s. The thickness of the separator plate obtained in this manner is 205 μm (measured at a load of 5 psi), and the geometric density is 1.15 g/cm³.

### LIST OF REFERENCE NUMBERS

(1) Monolayer of carbon fibre-reinforced carbon
(2) Duromer resin
(3) Fillers
(4) Separator plate

1-15. (canceled)

16. A separator plate, comprising: a monolayer of carbon fibre-reinforced carbon impregnated with a duromer resin, wherein the separator plate has a continuous electrically conductive carbon network and a thickness of less than 0.5 mm and a tensile strength greater than 30 MPa.

17. The separator plate according to claim 16, wherein the separator plate has the volume resistance of less than 8 mΩcm².

18. The separator plate according to claim 16, wherein the separator plate has a density of less than 1.7 g/cm³.

19. The separator plate according to claim 16, wherein the carbon fibre-reinforced carbon comprises a monolayer of a carbon fibre textile with carbon/binder bridges between the carbon fibres.

20. The separator plate according to claim 16, wherein the duromer resin comprises resins from the group of epoxy resin, phenolic resin, furan resin or benzoxazine resin.

21. The separator plate according to claim 16, wherein the duromer resin comprises dispersed fillers.

22. The separator plate according to claim 20, wherein mass fraction of the fillers is 0 wt. % to 40 wt. %.

23. The separator plate according to claim 16, wherein the separator plate has a permeation coefficient of less than 5×10⁻⁵ cm²/s.

24. The separator plate according to claim 16, wherein the surface of the carbon fibre-reinforced carbon impregnated with the duromer resin has a structuring.

25. The separator plate according to claim 21, wherein the cross section of the separator plate has a concentration gradient of the fillers.

26. A method for producing the separator plate according to claim 16, comprising the following steps:
a) Provision of a carbon fibre textile
b) Impregnation of the carbon fibre textile with a carbon donor
c) High-temperature treatment of the impregnated carbon fibre textile in an inert gas atmosphere at temperatures greater than 1300° C.
d) Provision of a duromer resin system
e) Impregnation of the carbon fibre-reinforced carbon obtained in step c) with the duromer resin system provided in step d)
f) Hardening and pressing of the resin-impregnated carbon fibre-reinforced carbon from step e) under a pressure of 1-50 bar

27. The method according to claim 26, wherein, following step f), the surface is activated by a grinding, blasting, chemical treatment or plasma treatment on both sides.

28. The method according to claim 26, wherein 0 wt. %-40 wt. % of fillers are dispersed in the duromer resin system.

29. The method according to claim 26, wherein the pressing step is carried out with a structured tool.
